(19) United States
(12) Patent Application Publication
(10) Pub. No.: US 2011/0239838 A1
(43) Pub. Date: Oct. 6, 2011

(54) INSULATED GLASS LINE HAVING A DYNAMIC BATCHLESS DIRECT FEED CUTTER

(75) Inventors: Akos Nagy, Zelienople, PA (US); Philip Plant, Zelienople, PA (US); Kevin Wehner, Zelienople, PA (US); Jason Satteson, Zelienople, PA (US)

(73) Assignee: HP3 Software, Inc., Sewickley, PA (US)

(21) Appl. No.: 12/900,458

(22) Filed: Oct. 7, 2010

Related U.S. Application Data
(60) Provisional application No. 61/249,587, filed on Oct. 7, 2009.

(51) Int. Cl. B26D 7/06

(52) U.S. Cl. 83/78

(57) ABSTRACT

An Insulated Glass (IG) line comprises a washer for washing lites; a spacer applicator for selectively attaching spacers to lites downstream of the washer; an assembler for coupling multiple lites with intervening spacer downstream of the spacer applicator; an unloading station for removing finished IGUs from the IG line downstream of the assembler; and a buffer storage unit upsteam of the washer and having i) at least one storage rack defining a plurality of lite storage locations, ii) a storage rack feeding unit configured to place lites into any storage location of each storage rack, and iii) a storage rack unloading unit configured to take lites from any storage location of each storage rack. The Insulated Glass (IG) line further includes a dynamic batch-less direct feed cutter upstream of the buffer storage unit.

### RELATED APPLICATIONS

The present application claims the benefit of U.S. Provisional Patent Application Ser. No. 61/249,587 entitled “An Insulated Glass Line having a Dynamic Batchless Direct Feed Cutter” filed on Oct. 7, 2009.

### BACKGROUND OF THE INVENTION

1. Field of the Invention

The present invention relates to glass processing equipment with dynamic production control. Specifically, the invention relates to an Insulated Glass (IG) line with a dynamic batch-less direct feed cutter.

2. Background Information

Insulated Glass Units-IGU

Insulated glass units are formed by multiple glass panes or “lites” assembled into units. The units are also commonly referred to as merely insulated glass (IG), or insulated glass units (IGU) in the United States and Australia. They are also commonly referred to as double glazing, double glazed units in Europe. For performance and evaluation standards see “ASTM E2190-08” which is the standard specification for “Insulating Glass Unit Performance and Evaluation”.

The IGUs use the thermal and acoustic insulating properties of a gas, which is often placed under reduced pressure (aka under a vacuum), contained in the space formed between the lites. IGUs can provide good insulation without sacrificing transparency also known as visual transmittance. Single glazed tinted and reflective glasses can provide similar thermal insulation, but for the same insulation performance are harder to see through and provide little protection against unwanted sound.

Most IGUs are double glazed (i.e. two spaced lites), but IGUs with three sheets or more, i.e. “triple glazing”, are becoming more common due to higher energy costs. IGUs may be framed in a sash, frame or in a curtain wall. IGUs are manufactured with glass lites typically in range of thickness from 3 mm to 10 mm, although greater widths are known for special applications. Laminated or tempered glass lites may also be used as part of the construction. Most IGUs are manufactured with the same thickness of glass lites used on both (or all) panes but special applications such as acoustic attenuation or security may require wide ranges of thicknesses for different panes to be incorporated in the same IGU.

While clear glass is the most common glass lite component of IGUs, tinted glass is be used in some IGUs to reduce solar heat gain or as an architectural feature. The principle colors available are bronze, gray and green. The degree of tint depends on both the composition of the glass and the thickness of the lite. Tinted glass is usually placed on the exterior of the IGU. The heat and sound insulation properties or scratch resistance or other properties of an IGUs may also be improved by the use of a film or coating applied to its surface. This film is typically made of polyester or metal, and may give the window a reflective appearance.

Further, Low-Emissivity Glass lites are also used in IGUs and is glass that has a thin coating, often of metal, on the glass within its airspace that reflects thermal radiation or inhibits its emission reducing heat transfer through the glass. A basic low-e coating allows solar radiation to pass through into a room.

There are two types of low-e coatings currently widely available, “hard-coat” and “soft-coat”. Hard-coat glass lites are manufactured by applying molten tin to the glass surface as the glass sheets are being manufactured. The tin bonds to the surface of the glass and forms a relatively thick coating. Hard-coat glass lites are considered a medium performance coating since the emissivity is greater compared to the soft-coat product. One advantage of hard-coat glass is that it does not require special handling in the IGU assembly line to maintain the surface's coating integrity and does not scratch easily. It does require that the glass surface in contact with the spacer be abraded to improve adhesion of the sealant. Soft-coat glass uses vacuum deposition to apply a thin metallic coating to the glass surface as an additional manufacturing step. The coating is fragile compared to hard coat glass, requiring special handling and storage for both the manufacturing process and IGU fabrication. It has been suggested that selecting a soft-coat glass over a hard-coat glass improves thermal performance of the IGU by about 13%. Most low-emissivity glass sold for IGU manufacturing is of the hard-coat type.

The glass panes of an IGU are separated by a spacer. Most spacers are constructed of either thin gauge steel or aluminum for thermal expansion stability or cost reasons. The spacer may alternatively be constructed of fiberglass or use a hybrid design of metal and plastic. The spacer may further be filled with desiccant to remove moisture trapped in the air space during manufacturing, preventing condensation from forming on an inner glass pane surface when the temperature falls below the dew point.

IGU thickness is often a compromise between maximizing insulating value and the ability of the framing system used to carry the unit and weight concerns. These issues can be advantageously addressed with other considerations, for example, a perfect vacuum provides the most thermal insulation value. Alternatively, a technique called evacuated glazing can be used to drastically reduce heat transfer through convection and conduction. These IGUs have most of the air removed from the space between the panes, leaving a partial vacuum. Another alternative is to replace air in the space with inert gases such as argon, as argon has a thermal conductivity 67% that of air, or krypton, where krypton has about half the conductivity of argon, or even xenon to increase the insulating performance. These gasses have a higher mass (density) compared to air but have costs that increase exponentially with the type of gas used, xenon being the most expensive. In general, the more effective a fill gas is at its optimum thickness, the thinner the optimum thickness is.

A muntin is technically described as a strip of material (often wood or metal or even plastic) separating and holding panes of glass lites in a window. Muntins are also called “glazing bars”, “astragals”, “muntin bars,” “false muntins” “grilles” or, somewhat confusingly, “mullions”. Many companies in the U.S. use the term “grille” when referring to a set of decorative muntin bars added to give a sash the appearance of a “true divided light” sash. In the IGU field decorative muntins

Glass Cutting Lines

Glass processing equipment including glass cutting lines that have glass cutting tables, are well-known in the art, such as those sold by the assignee of the present invention, Billco Manufacturing, Inc. The central piece of equipment in the glass cutting line is the glass cutting table, examples of which are described in U.S. Pat. Nos. 5,791,971, 6,463,762 and 6,810,784, which are incorporated herein by reference. The glass cutting table is designed to cut generally rectangular glass sheets into a plurality of individual glass work pieces for subsequent manufacturing. The typical glass cutting line will also include a sheet feeding device upstream of the glass cutting table for feeding the glass sheets to be cut to the glass cutting table. The sheet feeding device may be in the form of an air float table to which individual glass sheets to be cut are fed, such as from a storage rack, and then aligned prior to forwarding to the glass cutting table.

A known glass cutting line arrangement will also include a sorting device downstream of the glass cutting table where the cut glass sheets are individually sorted by the specific glass work pieces into storage racks, generally called harp racks. A harp rack is provided with a number of slots, such as 100, for receiving the individual cut glass work pieces. The sorting device may be formed as an air float table with a plurality of adjacent harp racks. The harp racks are moved to the next part of the assembly operation.

Existing glass cutting lines typically utilize a production control system designed to minimize scrap. Previously, a specific cutting schedule for a production run, or single batch, was prepared in advance by the control system. The production run essentially corresponded to the number of harp racks and associated slots at the sorting station. Basically, older optimization programs were used to determine the optimal cutting schedule for filling the slots of the harp racks with the desired glass work pieces.

The cutting schedule essentially refers to the collection of layouts of the individual glass work pieces on all the glass sheets to be cut for the production run or batch. Following the batch production run, the filled harp racks were moved to the next location in the manufacturing process. The older optimization systems were limited by several problems. First, each system was limited by the number of available slots in the available harp racks. In general, the greater the number of slots the greater the yield since the optimizing program will have a greater number of pieces to select from to maximize product yield. Second, the harp racks generally could not be moved until the entire production run is completed, including the re-cuts at the end of the batch process. Third, the existing last sheet problem increased yield loss, even with re-cuts incorporated into the last sheet. Additionally, the existing older systems do not easily accommodate special pieces not accounted for in the production run.

The problems with older optimizers on cutting lines were addressed by Billco Manufacturing with the development of the Batch Ban® glass equipment optimization product. This system provided a dynamic cutting line control system that includes an optimizer coupled to the controller of the glass cutting table optimizing the glass work piece layout on the individual sheets of glass. The optimizer includes a dynamically adjustable bias or biasing feature for favoring individual cut glass work pieces assigned to a leading storage position such as in a harp rack, whereby the bias will tend to position and cut the glass work pieces assigned to the leading position or harp rack on leading sheets to completely fill the leading harp rack in a minimum time. The control system further accommodates removal of a filled leading harp rack from the glass cutting line, with the system designating a new leading harp rack for the optimizer, which then dynamically adjusts the bias and associated cutting scheduling. This system provides an optimization system that operates “on the fly” allowing the previous batch type systems to be continuous or semi-continuous processes. The Batch Ban® product is described, in part in U.S. Pat. Nos. 7,043,323 and 6,879,873 and these patents are incorporated herein by reference.

The Batch Ban® product can also be described as overlapping batches that are dynamically optimized “on the fly”. The Batch Ban® product is not limited to the pieces designated for the storage locations currently at the cutter break out table. As noted in U.S. Pat. No. 6,879,873, it is also known to have one harp rack, or storage location, that is designated for “rare” pieces, or pieces that are not in the production cycle for some time, and this is called the rare rack. The rare rack acts as a storage location for pieces until needed, which is until the rack that they are associated with is moved into position on the break out table.

The commercial implementation of the Batch Ban® product has resulted in large commercial savings where implemented. There is a need to expand the applications for the dynamic optimization system of the Batch Ban® type product.

Tempering Lines

A separate glass processing step for many glass types is tempering through a tempering oven. Conventional tempering ovens will have a loading zone where the glass work pieces are loaded onto a moving bed of the furnace, a heating zone, a cooling zone and an unloading zone. A conveyer generally operates in a continuous fashion moving pieces through the tempering furnace. Tempering lines are well known in the art.

IG Assembly Lines

IGUs are manufactured on a made-to-order basis on factory production lines, such as the Billco Manufacturing Vertical I.G. line, or the GED Intercept™ IG line or the Lisec Vertical I.G. Line. For each individual IGU, the width and height dimensions of each lite, the thickness of the glass lites, the type of glass for each glass lite, the specific spacer, the inner pane gas (e.g., air, argon, xenon, krypton), if any, and treatment (i.e. partial vacuum level), spacer type, muntin type, if any, must be supplied to the I.G. assembly line.

On the I.G. assembly line, spacers of specific thicknesses may be cut and assembled into the required overall width and height dimensions and filled with desiccant. On an earlier or upstream glass cutting lines, glass panes of the relevant types are cut to size and supplied to the IG line directly or through a tempering line.

On the I.G. line the glass lites are washed to be optically clear. An adhesive sealant, such as polyisobutylene or PIB for short, is applied to the face of the spacer on each side and the appropriate lites pressed against the spacer. If the IGU is gas filled, two holes may be drilled into the spacer of the assembled unit, lines are attached to draw out the air out of the space and replaced with the desired gas, with the drilled holes being subsequently sealed. Alternatively the IG line may have what is known as an “online gas filler”, which removes the need to drill holes in the spacer. The units are then sealed on the edge side using a outer sealant such as either polysulphide or silicone sealant or similar material to prevent humid outside air from entering the unit. The desiccant will remove traces of humidity from the air space so that no water appears on the inside faces of the glass panes facing the air space during cold weather. Some manufacturers have developed specific processes that combine the spacer and desiccant into a single step application system. Internal or external muntins can be applied on the IG line which may include drilling attachment holes in selected locations.

Existing I.G. lines typically utilize a production control system designed to control the I.G. line processes and to identify or schedule the lites that need to be introduced into the I.G. line. The schedule created will identify what order the specific IGUs will be produced, which in addition to the specific order the lites need to be introduced into the I.G. Line the schedule will also identify what spacers need to be used for a specific piece, what muntins, what washing parameters, sealant parameters, gas parameters, and other operating parameters for the I.G. line.

There remains a need in the art to improve the IG Lines cycle time efficiency. It is an object of the present invention to improve the efficiencies of IGU production lines incorporating an IG Line Scheduler.

### SUMMARY OF THE INVENTION

In accordance with one aspect of the present invention, the present invention, in summary, a dynamic insulated glass unit (IGU or IG) assembly line with a just in time direct feed cutting table or line for supplying non-tempered glass lites. Dynamic within the meaning of this application defines that the schedule can be altered throughout the production run, for recuts, remakes and the like.

Another aspect of the invention provides a an Insulated Glass (IG) line comprising a cutting table; a breakout table adjacent the cutting table and adapted to receive lites from the cutting table; a buffer storage unit downstream of the breakout table and having i) at least one storage rack defining a plurality of lite storage locations, ii) a storage rack feeding unit configured to place lites into any storage location of each storage rack, and iii) a storage rack unloading unit configured to take lites from any storage location of each storage rack; a buffer storage unit feeding conveyor receiving lites from the breakout table and feeding the lites to the storage rack feeding unit; a washer for washing lites downstream of the storage rack unloading unit; a spacer applicator for selectively attaching spacers to lites downstream of the washer; an assembler for coupling multiple lites with intervening spacer downstream of the spacer applicator; and an unloading station for removing finished IGUs from the IG line downstream of the assembler. Within the meaning of this application downstream and upstream are in reference to the production flow direction of the assembly line which “flows” from the feeding table of the cutting table to the unloading station. Within the meaning of this application a unit that is adjacent another unit and delivers or receives lites (or other IGU components) to or from the adjacent unit will deliver or receive the lites (or other components) directly thereto, such as through a conveyor, without going through extraneous units.

The Insulated Glass (IG) line according to the invention may further include a tempered glass supply adjacent the buffer storage unit feeding conveyor wherein the buffer storage unit can selectively receive tempered glass lites from the tempered glass supply, and wherein the tempered glass supply is formed of a plurality of harp rack each rack having a plurality of tempered glass lite storage locations. The Insulated Glass (IG) line according to the invention may further include a feeding table upstream of the cutter, wherein the feeding table includes a plurality of work piece supply racks adjacent the feeding table. As noted the Insulated Glass (IG) line according to the invention further includes a dynamic IGU assembly line scheduler providing production control on the IG line.

Another aspect of the invention provides an Insulated Glass (IG) line comprising a washer for washing lites; a spacer applicator for selectively attaching spacers to lites downstream of the washer; an assembler for coupling multiple lites with intervening spacer downstream of the spacer applicator; an unloading station for removing finished IGUs from the IG line downstream of the assembler; and a buffer storage unit upsteam of the washer and having i) at least one storage rack defining a plurality of lite storage locations, ii) a storage rack feeding unit configured to place lites into any storage location of each storage rack, and iii) a storage rack unloading unit configured to take lites from any storage location of each storage rack.

The particular advantages of the present invention will be described in connection with the attached figures wherein like reference numerals represent like elements throughout.

### BRIEF DESCRIPTION OF THE DRAWINGS

FIG. 1 is a schematic plan view of an Insulated Glass (IG) line with a dynamic batch-less direct feed cutter according to the present invention;

FIG. 2 is a schematic perspective view of an IG line similar to that shown in FIG. 1.

### DETAILED DESCRIPTION OF THE PREFERRED EMBODIMENTS

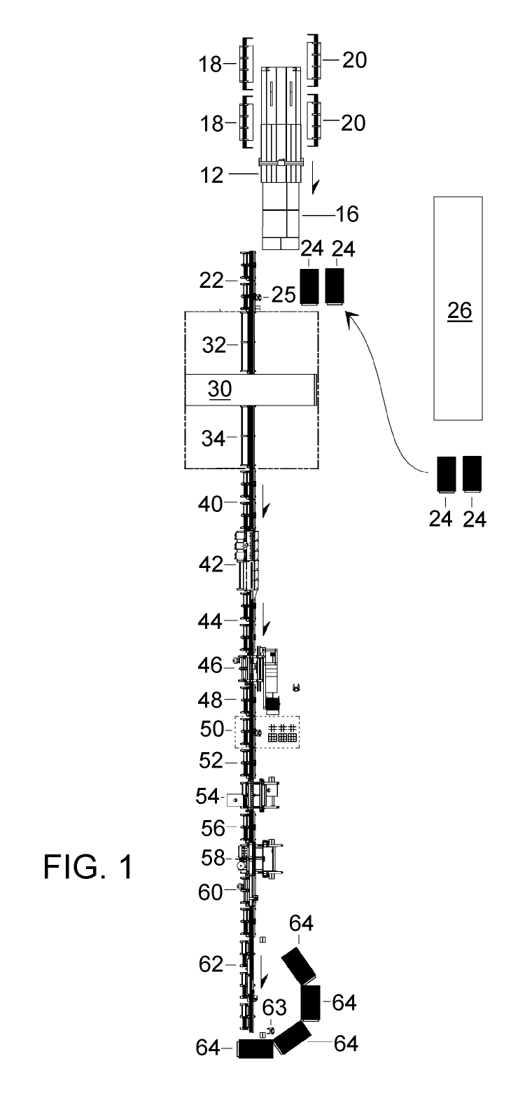

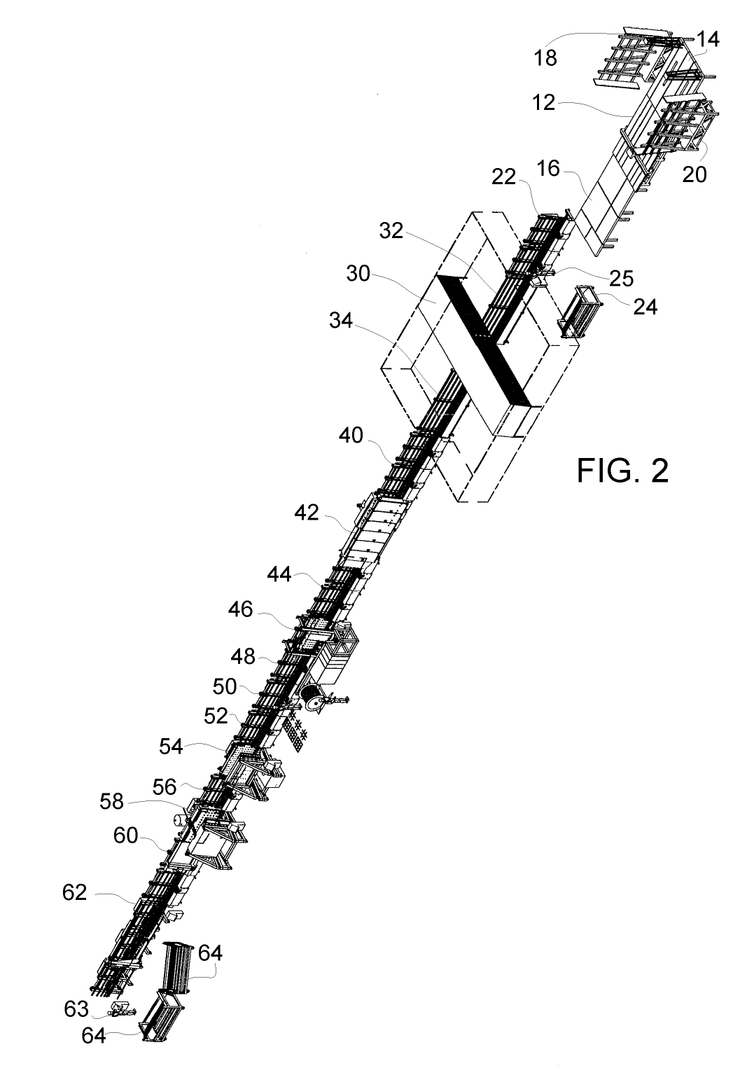

FIGS. 1 and 2 schematically illustrate a dynamic Insulated Glass Unit assembly line 10 according to the present invention.

A key component of the IG line 10 of the present invention is the direct feed from a cutting line including a central component of the cutting line which is a computer controlled of CNC glass cutting table 12 for cutting sheets of glass into cut glass work pieces or lites for direct feed into the IG line 10. The table is controlled with a dynamic controller that controls the entire line 10.

Schedulers, within the meaning of this application, can either be batch schedulers or dynamic schedulers. A Batch scheduler will consider and place each glass work piece (each glass lite or muntin or spacer or the like) within ONLY one schedule, which is run until that schedule is completed. A Batch scheduler will not consider a given glass work piece within two separate schedules. Replacement pieces are considered as distinct pieces for the purpose of this definition as they require a uniquely separate work piece to form these components.

In contrast with a Batch scheduler, a Dynamic scheduler will consider and place at least some of the glass work pieces within multiple schedules. The dynamic term references the ability of the scheduler to “re-optimize” the schedule following a given set of production, such as after each IGU is assembled, whereby the position of an IGU can change in the final production schedule as the scheduler re-schedules. A Dynamic scheduler may be accurately described as utilizing a series of overlapping batches. The leading example of a Dynamic scheduler is the Batch Ban® product for cutting table optimizers from HP3. Another manner of describing and defining the Dynamic scheduler is that in a Dynamic scheduler the pool of inputs of potential IGUs and associated glass work pieces to be scheduled and considered is continuously changing during a production run. This contrasts with a Batch scheduler which utilizes a fixed pool of inputs of potential glass work pieces to be scheduled for that batch production run.

It is well known that glass work pieces can be and are damaged at every stage of the production cycle. It is often considered that the more handling steps that are incurred with a work piece the greater the likelihood of damage to the work piece. Regardless of the cause, the damaged pieces must be replaced. Traditionally, in batch production, these replacement pieces are run following the completion of the current batch. This final replacement batch can significantly hinder the production as it may result in exceptionally low yields as there can be very limited glass types in this final batch process. Within the meaning of this application replacement pieces references those work pieces that have been damaged in processing and need to be replaced or remade. The phrase replacement pieces is intended to be a generic encompassing term for these components. Replacement pieces are often very critical in plant production, as, for example, a whole order may be held up until a few replacement pieces are formed (cut and processed) to complete the order.

The present invention operates with a dynamic cutting table and IG line optimizer and in one embodiment of the invention the dynamic cutting table optimizer includes a biasing factor for scheduling work pieces and wherein work pieces dynamically scheduled directly into the cutting table optimizer by the IG line operators are given the highest priority. The Batch Ban® optimizer provides such a cutting table optimizer.

The cutting table 12 itself is well known in the art such as those sold by Billco Manufacturing, Inc. The table 12 generally includes a cutting or scoring head mounted on a carriage which, in turn, is mounted on a bridge over the table surface. The bridge carries a track along which the carriage moves, and the bridge, in turn, is moved along tracks adjacent the table. The carriage and bridge from an X-Y positioning system for the cutting or scoring head.

A feeding device 14 is provided upstream of the table 12 for feeding glass sheets 14 to the glass cutting table 12. The feeding device or table 14 may include an air float table, such as manufactured by Billco Manufacturing Inc. Additionally the feeding device 14 may include an alignment mechanism for properly positioning the glass sheets on the table 12. The feeding device 14 may include manual input for loading and positioning the sheets on the cutting table 12 or the feeding may be automated. Adjacent the feeding table 14 is shown a plurality of racks 18 and racks 20, representing two distinct types of glass to be supplied to the cutting table 12. For example racks 18 may hold coated glass sheets while racks 20 may hold clear glass sheets. The racks 18 and 20 may each hold distinct types of glass types on a single rack but it will be common to find common glass types on each rack 18 or 20.

A breakout table 16 is downstream of the table 12 for breaking out the cut (actually scored) glass work pieces and moving the cut glass work pieces to an inline feeding conveyor 22. Shown in the figures is an operator 25 at the breakout table 16 for manually performing the breakout, and recording broken pieces and the like. The loading and inspection aspects can be automated through a pick and place robot or other automated means. With an operator 25 there will be a monitor, with input capabilities, that will identify which pieces are located on specific places on cut glass sheets coming from the cutting table. Further the operator 25 will be instructed as to what order to place pieces upon the conveyor 22. The cutter 12 is thus considered in-line with the remainder of the IG line.

The glass lites coming from the cutter 12 are non-tempered glass lites, which will be used in at least some IGUs formed on the IG line 10. Additionally the operator 25 has access to harp racks 24 forming a tempered glass supply coming from the output of a tempering line 26, which is typically remote from the IG line. The tempering line is conventional and must be fed by a cutter as well. Examples of tempering lines can be seen in pending application PCT/US2008/074127 and shown in publication number 2009/055135 which is incorporated herein by reference.

The dynamic insulated glass unit (IGU) assembly line 10 scheduler provides for production control of the insulated glass unit assembly line 10 whereby the operator 25 is instructed of which pieces from the tempering racks 24 to place onto the conveyor 22.

The conveyor 22 (also called buffer storage unit feeding conveyor) feeds to a transverse moving conveyor 32, or a storage rack feeding unit, that can place each work piece or lite into any one of a plurality of holding slots in a storage rack 30. A similar transverse conveyor 34, or a storage rack unloading unit, can pull any lite from any slot in the rack 30 to the remainder of the IG line 10. The input conveyor 32, output conveyor 34 and rack 30 form a buffer, also called a “rare” rack or a buffer storage unit, allowing the IG line to alter the order of operation on specific cut lites. The buffer gives great flexibility to the overall operation of the line 10.

The output conveyor 34 will feed the appropriate lites in the appropriate order for forming IGUs to a conveyor 40 at the beginning of what is a conventional IG line.

Following conveyor 40 is a washer 42 for cleaning the glass, and following the washer 42 a conveyer 44 will transport the lites to a spacer applicator 46. Here the spacer used is a coiled spacer, such as developed by IET. Other spacers, coiled and non-coiled types can be used on the IG line 10. Conveyor 48 takes the lites (and applied spacer) from the spacer applicator 46 to muntin applicator 50, although not all IGUs receive muntins.

Conveyor 52 transports the lites (and spacer and muntins, if any) to an assembler 54 in which the multiple panes forming the IGU are attached. Conveyor 56 transports the assembled IGU to the gas filler 58 followed by a plugging unit 60. Following the plugging a final or secondary seal is added to complete the IGU at 62.

The IGU assembly line 10 includes the unloading (and inspection) station represented by worker 63 at an end of the IGU assembly line 10. The unloading station includes a changeable set of uniquely identifiable IGU storage locations formed on harp racks 64 that are mounted adjacent the unloading station. Each harp rack 64 includes a plurality of storage locations, with each storage loading location adapted to receive an IGU therein finished from the IGU assembly line. Although not every storage location may receive an IGU as an order may only need a partial rack. The worker 63 can be replaced with a pick and placerobot with appropriate automated inspection device.

A changeable identifiable subset of the set of uniquely identifiable IGU storage locations is formed by a leading harp rack 64 which is adjacent the unloading station and defines the next in line set of IGUs to be shipped from the IGU assembly line 10. This rack 64 may constitute an order to be filled, although an order may comprise multiple racks 64 as well. In addition a single rack 64 may form two complete orders, but that is not a significant concern for the scheduler.

A monitor, with input capabilities, is provided for the worker 63 and is coupled to the scheduler. The monitor will identify the order of finished IGU into the harp racks 64. A buffer or rare rack, not separately identified) may be used to allow the line 10 to produce an IGU that is not needed for some time in the future (i.e. the rack that this piece is received on for shipping is not yet at the station.

The advantage of the IG line 10 is the provision of a direct feed cutter 12 for non-tempered glass lites. The control of the cutter 12 is based upon the desired output of the IG line at racks 64, with the controller knowing the operational parameters and timing of the line 10 so that it can be operated, to the greatest extent possible in a just in time fashion for supplying non-tempered glass lites to the line 10. The buffer 30 allows the cutter to increase efficiencies in operating in the just in time manner by allowing the cutter to use later needed pieces to improve the yield on the glass sheets cut on the cutter 12. This represents an application of the production control found in the Batch Ban® products of HP3 and described in U.S. Pat. Nos. 7,043,323 and 6,879,873 and these patents are incorporated herein by reference, however the output locations for this application are actually the outputs in racks 64. Consequently the cutter 12 scheduler is integrated with, and not easily separable from the IG line scheduler. The scheduler for cutter 12 is dynamic to accommodate remakes as needed on the fly.

In an alternative arrangement the Tempering line 26 can also be directly fed into the IG line 10 rather than remotely through racks 24 as shown. However, the integrated IG and cutter line of FIG. 1 is about 250′ such that the space requirements of further adding a direct feed tempering line 26 severely limits this possibility.

As noted above the present invention provides an Insulated Glass (IG) line 10 comprising a cutting table 12; a breakout table 16 adjacent the cutting table 12 and adapted to receive lites from the cutting table 12; a buffer storage unit (30, 32 and 34) downstream of the breakout table 16 and having i) at least one storage rack 30 defining a plurality of lite storage locations, ii) a storage rack feeding unit 32 configured to place lites into any storage location of each storage rack 30, and iii) a storage rack unloading unit 34 configured to take lites from any storage location of each storage rack 30; a buffer storage unit feeding conveyor 22 receiving lites from the breakout table 16 and feeding the lites to the storage rack feeding unit 32; a washer 42 for washing lites downstream of the storage rack unloading unit 34; a spacer applicator 46 for selectively attaching spacers to lites downstream of the washer 42; an assembler 54 for coupling multiple lites with intervening spacer downstream of the spacer applicator 46; and an unloading station for removing finished IGUs from the IG line downstream of the assembler 5.

The Insulated Glass (IG) line according to the above description further includes a tempered glass supply (racks 24) adjacent the buffer storage unit feeding conveyor 22 wherein the buffer storage unit (30, 32 and 34, collectively) can selectively receive tempered glass lites from the tempered glass supply formed by racks 24. The Insulated Glass (IG) line according to above described invention further includes a dynamic IGU assembly line scheduler providing production control on the IG line.

Although the present invention has been described with particularity herein, the scope of the present invention is not limited to the specific embodiment disclosed. It will be apparent to those of ordinary skill in the art that various modifications may be made to the present invention without departing from the spirit and scope thereof.

What is claimed is:

1. An Insulated Glass (IG) line with a dynamic batch-less direct feed cutter.

2. The Insulated Glass (IG) line according to claim 1 further including a buffer storage unit downstream of the cutter and having i) at least one storage rack defining a plurality of lite storage locations, ii) a storage rack feeding unit configured to place lites into any storage location of each storage rack, and iii) a storage rack unloading unit configured to take lites from any storage location of each storage rack.

3. The Insulated Glass (IG) line according to claim 2 further including a tempered glass supply adjacent the buffer storage unit feeding conveyor wherein the buffer storage unit can selectively receive tempered glass lites from the tempered glass supply.

4. The Insulated Glass (IG) line according to claim 3 wherein the tempered glass supply is formed of a plurality of harp rack each rack having a plurality of tempered glass lite storage locations.

5. The Insulated Glass (IG) line according to claim 1 further including a feeding table upstream of the cutter.

6. The Insulated Glass (IG) line according to claim 5 wherein the feeding table includes a plurality of work piece supply racks adjacent the feeding table.

7. The Insulated Glass (IG) line according to claim 1 further including a dynamic IGU assembly line scheduler providing production control on the IG line including the cutter.

8. An Insulated Glass (IG) line comprising
a) A cutting table;
b) A breakout table adjacent the cutting table and adapted to receive lites from the cutting table;
c) A buffer storage unit downstream of the breakout table and having i) at least one storage rack defining a plurality of lite storage locations, ii) a storage rack feeding unit configured to place lites into any storage location of each storage rack, and iii) a storage rack unloading unit configured to take lites from any storage location of each storage rack;
d) A buffer storage unit feeding conveyor receiving lites from the breakout table and feeding the lites to the storage rack feeding unit;
e) A washer for washing lites downstream of the storage rack unloading unit;
f) A spacer applicator for selectively attaching spacers to lites downstream of the washer;
g) An assembler for coupling multiple lites with intervening spacer downstream of the spacer applicator;
h) An unloading station for removing finished IGUs from the IG line downstream of the assembler.

9. The Insulated Glass (IG) line according to claim 8 further including a tempered glass supply adjacent the buffer storage unit feeding conveyor wherein the buffer storage unit can selectively receive tempered glass lites from the tempered glass supply.

10. The Insulated Glass (IG) line according to claim 9 wherein the tempered glass supply is formed of a plurality of harp rack each rack having a plurality of tempered glass lite storage locations.

11. The Insulated Glass (IG) line according to claim 8 further including a feeding table upstream of the cutter.

12. The Insulated Glass (IG) line according to claim 11 wherein the feeding table includes a plurality of work piece supply racks adjacent the feeding table.

13. The Insulated Glass (IG) line according to claim 8 further including a dynamic IGU assembly line scheduler providing production control on the IG line.

14. An Insulated Glass (IG) line comprising:
a) A washer for washing lites;
b) A spacer applicator for selectively attaching spacers to lites downstream of the washer;
c) An assembler for coupling multiple lites with intervening spacer downstream of the spacer applicator;
d) An unloading station for removing finished IGUs from the IG line downstream of the assembler; and
e) A buffer storage unit upsteam of the washer and having i) at least one storage rack defining a plurality of lite storage locations, ii) a storage rack feeding unit configured to place lites into any storage location of each storage rack, and iii) a storage rack unloading unit configured to take lites from any storage location of each storage rack.

15. The Insulated Glass (IG) line according to claim 14 further including a tempered glass supply adjacent the buffer storage unit feeding conveyor wherein the buffer storage unit can selectively receive tempered glass lites from the tempered glass supply.

16. The Insulated Glass (IG) line according to claim 15 wherein the tempered glass supply is formed of a plurality of harp rack each rack having a plurality of tempered glass lite storage locations.

17. The Insulated Glass (IG) line according to claim 14 further including a dynamic batch-less direct feed cutter upstream of the buffer storage unit.

18. The Insulated Glass (IG) line according to claim 17 further including a dynamic IGU assembly line scheduler providing production control on the IG line including the cutter.

19. The Insulated Glass (IG) line according to claim 18 further including a tempered glass supply adjacent the buffer storage unit feeding conveyor wherein the buffer storage unit can selectively receive tempered glass lites from the tempered glass supply.

20. The Insulated Glass (IG) line according to claim 19 further including a feeding table upstream of the cutter, wherein the feeding table includes a plurality of work piece supply racks adjacent the feeding table.
